(19) United States
(12) Patent Application Publication
(10) Pub. No.: US 2004/0190907 A1
(43) Pub. Date: Sep. 30, 2004

(54) All-optical reference clock for generating stable RF comb spectrum

(75) Inventor: Kerry I. Litvin, Huntingdon Valley, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General instrument Corporation

(21) Appl. No.: 10/397,814

(22) Filed: Mar. 25, 2003

(51) Int. Cl. H04B 10/12

(52) U.S. Cl. 398/149

(57) ABSTRACT

An all-optical reference clock used to generate a stable radio frequency (RF) comb spectrum. The all-optical reference clock includes a fiber ring laser, a tunable mode selection filter and one or more phase locked loop (PLL) control circuits. The fiber ring laser has an effective loop circumference which produces a fundamental frequency mode spacing fₗ. The all-optical reference clock is configured to output a plurality of equally spaced frequencies which include a frequency fₒ and the harmonics thereof. The PLL control circuit receives a sample of the spaced frequencies and adjusts the tunable mode selection filter to maintain the desired spacing between the spaced frequencies. In one embodiment, a line-stretching drum, having a variable diameter and controlled by the PLL control circuit, is used to tune the mode selection filter. In another embodiment, a voltage controlled oscillator (VCO) controls a Mach-Zehnder modulator to eliminate undesired frequencies.

### BACKGROUND OF THE INVENTION

1. Field of the Invention

The present invention generally relates to the generation of clocking reference signals for one or more optical communications networks.

2. Background Information

Every modern baseband digital optical communications system requires a particular synchronization scheme in order to properly maintain the flow of data within a network. Data synchronization may occur at several levels, depending upon the particular architecture and protocols being utilized. When synchronization occurs at a bit level, individual bits must be precisely synchronized to a system clock so that they are properly spaced and timed prior to being transmitted into the network.

In the ring configuration of an erbium doped fiber ring laser (EDFRL), a phase locked loop (PLL) is used to stabilize the frequency spacings between the multitudes of optical modes being generated by the EDFRL. The EDFRL is, by construction, a multimode optical source where the allowed longitudinal modes of the EDFRL simply satisfy the boundary condition:

$$cos ( \frac{2 \cdot π \cdot f \cdot n}{c} \cdot x ) = cos ( \frac{2 \cdot π \cdot f \cdot n}{c} \cdot ( x + N \cdot L ) ) \qquad ( 1 )$$

where f is the optical frequency, n is the index of refraction in the fiber, c is the speed of light in vacuum, x is the positional coordinate along the circumference of the ring relative to a coordinate system, L is the effective circumference of the ring which includes the actual physical length of the fiber ring plus any additional effective lengths due to the various components inserted into the ring which cause additional delays, and N is an integer (N=0, 1, 2, 3 . . . ). Equation (1) is equivalent to writing:

$$( \frac{2 \cdot π \cdot f \cdot n}{c} ) \cdot ( N \cdot L ) = 2 \cdot M \cdot π \qquad ( 2 )$$

where M is also an integer (M=0, 1, 2, 3 . . . ).

Letting f·N=fₘ where fₘ are the mode frequencies, then Equation (2) immediately reveals the allowed mode frequencies of the fiber laser based solely upon its physical layout:

$${f}_{m} = M \cdot \frac{c}{n} \cdot \frac{1}{L} \qquad ( 3 )$$

and the mode spacing is therefore given by:

$$\frac{\partial {f}_{m}}{\partial M} = \frac{c}{n} \cdot \frac{1}{L} = {f}_{1} \qquad ( 4 )$$

The modes are equally spaced and are all harmonics of the fundamental frequency fₗ.

A solution based solely upon geometrical considerations allows an infinite number of longitudinal modes. The gain spectrum of the erbium fiber puts finite limits on the lower and upper frequencies that can exist in the ring laser. Erbium fiber (amplifiers) can typically supply enough gain to overcome the losses in the ring within a band of wavelengths ranging from about 1520 nm through 1580 nm with the optimal being between 1530 through 1560 nm. The wavelength band from 1520 to 1580 nm corresponds to a frequency band of 7.495 THz while the reduced band from 1530 nm through 1560 nm corresponds to a frequency range of 3.771 THz. The total number of modes that exist is given by the ratio of the amplifier bandwidth divided by fₗ or more generally:

$${M}_{max} = ( \frac{c}{{λ}_{MIN}} - \frac{c}{{λ}_{MAX}} ) \cdot \frac{n \cdot L}{c} = ( \frac{1}{{λ}_{MIN}} - \frac{1}{{λ}_{MAX}} ) \cdot L \cdot n \qquad ( 5 )$$

Accounting for the M=0 term, the total number of modes which can exist is 1+Mₘₐₓ.

For a typical EDFRL with an effective circumference L of about 25 meters, the total number of modes is quite large as the mode spacing is only about 8.17 MHz (n=1.47 in fiber). Mₘₐₓ=918000 for the full erbium band and 462000 for the reduced more optimal band. If a band restricting optical filter is inserted into the EDFRL, then the number of allowed modes is given by the reduced EDFRL bandwidth divided by fₗ. For a 3 GHz band pass filter in an EDFRL with an effective circumference L of about 25 meters, the number of allowed modes which can exist is thus reduced to no more than 367 with the actual number being much smaller due to the filter's roll-off characteristics killing the modes that are found closest to its skirts.

When a multimode optical signal is detected by a photoreceiver with an appropriate bandwidth, the optical modes “beat” with one another producing an RF comb spectrum with lines spaced fₗ apart from one another starting at zero frequency and moving up in steps of fₗ. Either the bandwidth of the EDFRL or the photoreceiver circuit determines the maximum observable (usable) beat frequency.

FIG. 1 shows a conventional unfiltered EDFRL configuration 100 including an erbium doped fiber amplifier (EDFA) 105, an optical isolator 110 and an optical directional coupler 115A (e.g., a fusion spliced fiber tap coupler). An optical spectrum analyzer (OSA) 120 is in communication with the coupled port of the optical directional coupler 115A via the direct port of a second optical directional coupler 115B. The OSA 120 is used to view the multimode amplified spontaneous emission (ASE) spectrum generated by the EDFRL configuration 100. A radio frequency spectrum analyzer (RF-SA) 125 is in communication with the coupled port of second optical directional coupler 115B via a photoreceiver 130. The RF-SA 125 is used to view the resulting RF comb spectrum, due to the modes beating in the photoreceiver 130.

FIG. 2 shows a conventional filtered EDFRL configuration similar to FIG. 1 with the additional of a tunable filter 205. The OSA 120 is used to view the multimode ASE spectrum and a laser line at the passband wavelength of tunable filter 205. The RF-SA 125 is used to view the resulting band limited RF comb spectrum, due to the modes beating in the photoreceiver 130.

### SUMMARY OF THE INVENTION

The present invention is an all-optical reference clock for outputting a stable radio frequency (RF) comb spectrum. The all-optical reference clock includes a fiber ring laser having an effective loop circumference which produces a fundamental frequency mode spacing fₗ, a tunable mode selection filter in communication with the fiber ring laser, and a phase locked loop (PLL) control circuit in communication with the fiber ring laser.

The PLL control circuit includes a frequency reference source oscillating at the frequency fₗ, and a bandpass filter having a center frequency fₒ equal to a predetermined multiple of the frequency fₗ. The all-optical reference clock is configured to output a plurality of equally spaced frequencies which include the frequency fₒ and the harmonics thereof. The PLL control circuit receives a sample of the spaced frequencies and adjusts the tunable mode selection filter to maintain the desired spacing between the spaced frequencies.

In one embodiment, the all-optical reference clock may further include a line-stretching drum in communication with the PLL control circuit. The line-stretching drum has a variable diameter. The tunable mode selection filter includes a length of fiber wrapped around the line-stretching drum, and the mode selection filter is tuned as the diameter of the line-stretching drum changes in response to a signal received from the PLL control circuit. The line-stretching drum may be a piezo-electric line-stretching drum.

In another embodiment, the all-optical reference clock may include a second PLL control circuit in communication with the frequency reference source of the original PLL control circuit. The second PLL control circuit may include an optical modulator in communication with the fiber ring laser. The optical modulator prohibits undesired frequencies from passing through. The second PLL control circuit may also include a voltage controlled oscillator (VCO) which supplies a modulation signal to the optical modulator. The frequency of the modulation signal is set to the lowest frequency in the RF comb spectrum outputted by the all-optical reference clock.

The optical modulator may be an optical Mach-Zehnder modulator. The frequency of the modulation signal may be about 51.84 MHz. The mode selection filter may have a free spectral range (FSR) equal to about 51.84 MHz and the harmonics thereof. The frequency fₗ may be about 5.184 MHz. The frequency fₒ may be about 51.84 MHz. The predetermined multiple may be ten. The fiber ring laser may be an erbium doped fiber ring laser (EDFRL). The tunable mode selection filter may limit the number of the spaced frequencies.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic diagram of a conventional unfiltered EDFRL configuration;

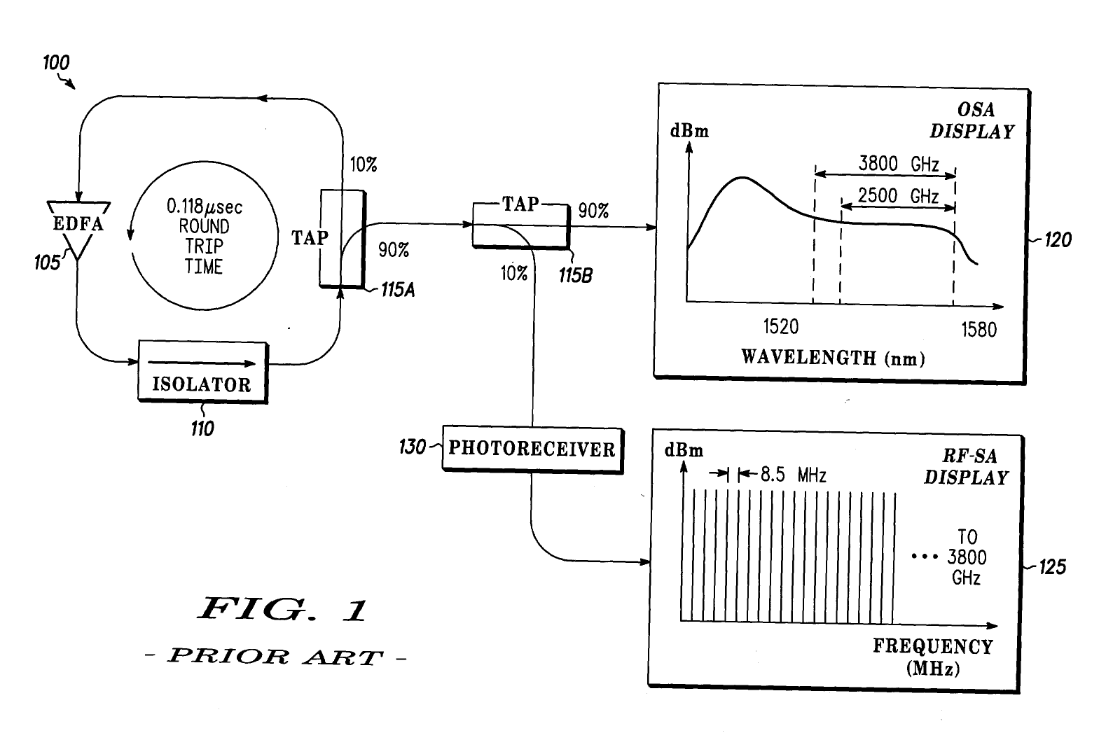

FIG. 2 is a schematic diagram of a conventional filtered EDFRL configuration;

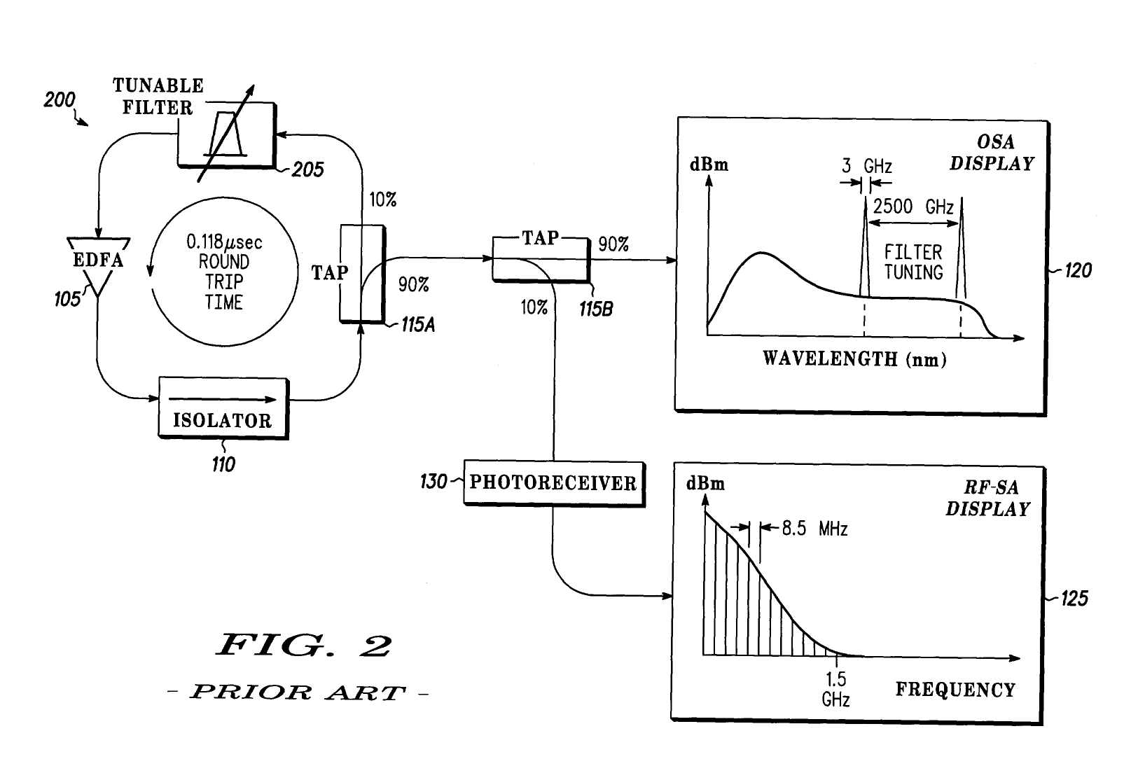

FIG. 3 is a schematic diagram of an all-optical reference clock that produces an OC-N spaced comb spectrum using a single PLL control circuit in accordance with the present invention; and

FIG. 4 is a schematic diagram of an all-optical reference clock that produces an OC-N spaced comb spectrum using two PLL control circuits in accordance with the present invention.

### DETAILED DESCRIPTION OF THE INVENTION

The present invention effectively produces an optical comb spectrum with precisely spaced wavelengths that serve to supply a complete spectrum of harmonically related clocking (synchronization or timing) signals ranging from a few megahertz (10⁶ Hz) to several terahertz (10¹² Hz). The present invention may find direct uses in various instrumentation applications, and utilizes standard off-the-shelf RF and optical components, making it relatively inexpensive to manufacture. The present invention enables the proper selection of the mode spacing, fₗ, and stabilization of the modes using a phase locked loop (PLL) control circuit which can be easily controlled via digital means. A detected RF comb spectrum results from the modes beating together at a photoreceiver (i.e., photodiode), and can be utilized as a frequency reference source for various system applications including timing in digital systems and RF frequency conversion in analog systems. Additionally, the present invention provides a multitude of harmonically related reference signals. Thus, the present invention can support slow timing processes through ultra-high speed clocking requirements or, in the analog system case, it can support low frequency translations or ultra high frequency conversions. An additional advantage is the fact that the reference signals are generated in an all-optical fashion and is immediately distributed throughout an optical communications network with minimal loss and without requiring an initial electrical-to-optical conversion.

The EDFRL is designed such that the effective length, L, will produce a fundamental mode spacing, fₗ, approximately equal to the lowest reference frequency of interest, f_{REF0}, or an integer divisor there of:

$${f}_{1} = \frac{c}{n} \cdot \frac{1}{L} = \frac{{f}_{REF0}}{K} \qquad ( 6 )$$

where K is an integer (K=1, 2, 3 . . . ).

If, for example, the standard OC-n optical data rates were to be used in a digital system, then f_{REF0} corresponds to OC-1 (f_{REF0}=OC-1=51.84 MHz). The OC-1 frequency dictates an effective loop circumference of about 3.939 meters. In reality, such a small circumference EDFRL is quite difficult to build and the small lengths will also severely limit the available output power in the optical comb spectrum because the length of the erbium doped fiber will have to be quite short. If the loop were designed such that K=10 then fₗ=5.184 MHz. The effective circumference is about 39.389 meters. Such a length allows for a much easier EDFRL construction with the added advantage that significant power is available to the optical comb spectrum when the length of the erbium doped fiber is made significantly longer.

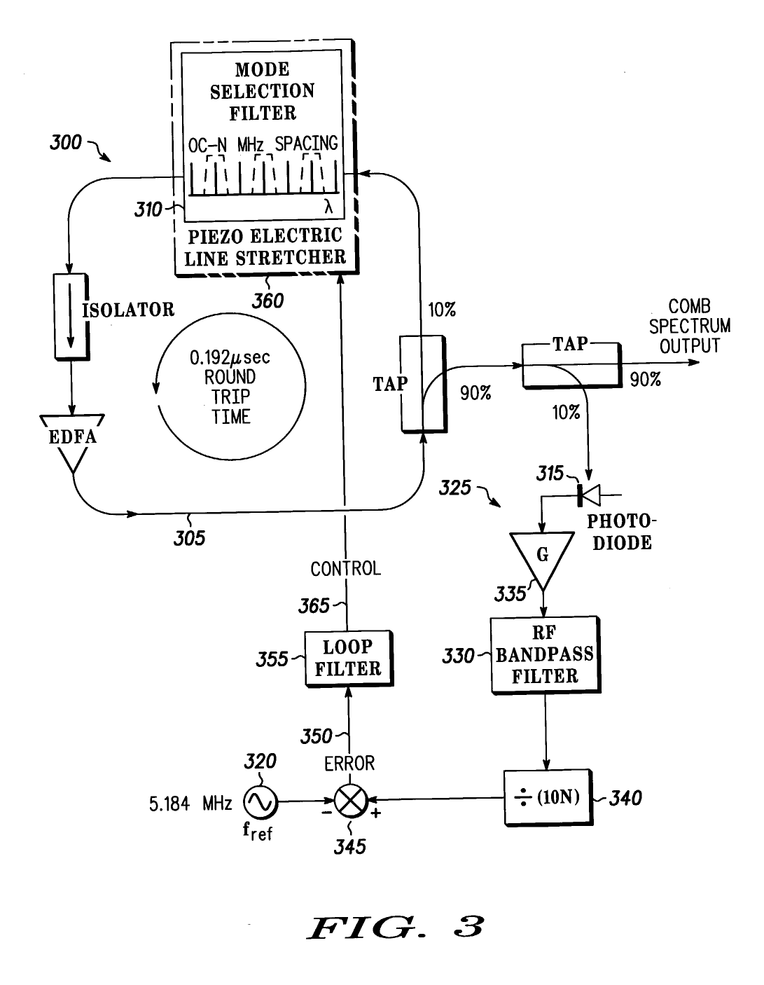

FIG. 3 shows an exemplary all-optical reference clock 300 for outputting a stable radio frequency (RF) comb spectrum in accordance with the present invention. The all-optical reference clock 300 produces a harmonic comb of reference signals spaced precisely OC-N MHz apart from one another, where OC-N is the lowest data rate utilized in the system. Any integer multiple of OC-N may also be utilized as these frequencies are also available from the all-optical reference clock 300.

The all-optical reference clock 300 includes an EDFRL 305. The effective loop circumference of the EDFRL 305 produces an unfiltered mode spacing of 5.184 MHz, which is one-tenth the fundamental standard frequency of 51.84 MHz for OC-1. The all-optical reference clock 300 allows the size of a laser to be large enough so that it can more easily be built and also produce sufficient output power in its comb spectrum. The fₗ frequency of 5.184 MHz, however, implies that there are at least ten times as many harmonic frequencies present than are required since only one out of every ten frequencies fall on a standard OC-n data rate. In order to address this issue, a tunable mode selection filter 310 with a free spectral range (FSR) equal to OC-N is inserted in the EDFRL 305. In this case, OC-N is the lowest standard data rate to be used in the system. If OC-1 (51.84 MHz) were the lowest rate required, the tunable mode selection filter 310 has an FSR of 51.84 MHz and the optical comb spectrum contains modes spaced 51.84 MHz apart. The detected RF spectrum contains a reference signal at every OC-n frequency from OC-1 up to the frequency limit of the photodiode 315. If OC-3 is the lowest data rate required, the tunable mode selection filter 310 has an FSR of 155.52 MHz, and the optical comb spectrum contains modes spaced 155.52 MHz apart. The detected RF spectrum contains a reference signal at every third OC-n frequency (OC-3, OC-6, OC-9 . . . ) up to the frequency limit of the photodiode 315.

The all-optical reference clock 300 further includes a PLL 325 by which the mode spacing can be stabilized. The PLL 325 does this by comparing a very stable 5.184 MHz frequency produced by a crystal frequency reference source 320 to one of the harmonic frequencies (the 10N^{th}) that is generated by the optical modes beating together at the photodiode 315. The 10N^{th} harmonic, in this case, corresponds to the OC-N standard frequency since 5.184 MHz is “OC-1/10”. The harmonic is selected from the comb of RF frequencies by placing a bandpass filter 330, with correct center frequency, (fₒ=5.184×10×N MHz), and appropriate bandwidth to select only the 10Nₜₕ harmonic, at the output of an RF amplifier 335 that follows the photodiode 315. Before the phase/frequency comparison can take place, the selected harmonic frequency must first be divided by the correct factor that brings this frequency to (in this particular case) 5.184 MHz. In the all-optical reference clock 300, a 10N division factor of a frequency divider 340 is used since 5.184 MHz is “OC-1/10” and the comparison is being made to the IONth harmonic. A phase/frequency detector 345 produces an error signal 350 that has a magnitude and a polarity which are commensurate with the phase/frequency error that has been sensed. The error signal 350 is conditioned and scaled by a loop filter 355 so that it is suitable for controlling the actual apparatus used to adjust the allowed longitudinal optical mode spacing of the all-optical reference clock 300.

A piezo-electric line-stretching drum 360 is used to lock the mode spacing of the all-optical reference clock 300. The piezo-electric line-stretching drum 360 expands and contracts its radius in accordance with the control voltage 365 that is applied. A length of fiber, which is part of the tunable mode selection filter 310, is wrapped around the drum 360 and, as its diameter grows or shrinks, it subsequently stretches or contracts this length of fiber. The actual change in the fiber length is rather small, as the glass in the fiber is not particularly elastic in nature. Nevertheless, so long as the crystal frequency reference source 320 is relatively stable and the dimensions of the fiber lengths, from which it is constructed, are made within reasonable tolerances, then the piezo-electric line-stretching drum 360 is able to provide enough of a tuning range to keep the desired mode spacing fixed over extended periods of time.

The passbands of the tunable mode selection filter 310 have some finite bandwidth, and each longitudinal optical mode may exist anywhere within one of the individual passbands of the tunable mode selection filter 310.

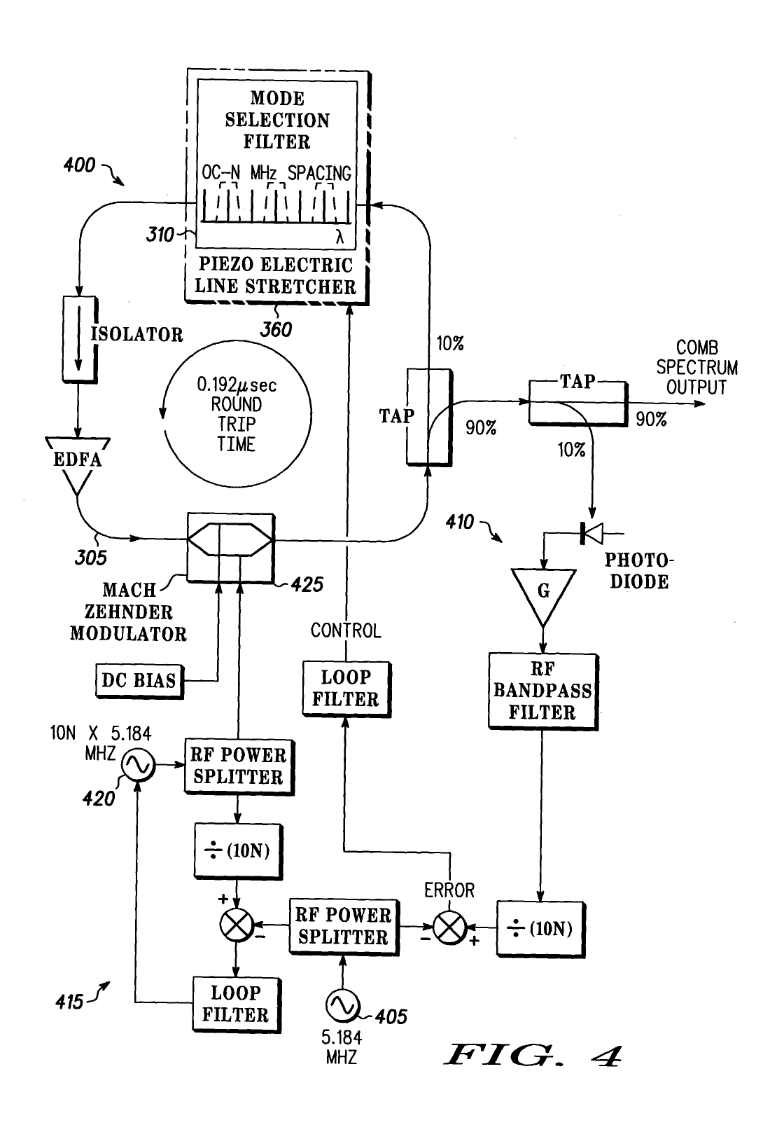

FIG. 4 shows an exemplary all-optical reference clock 400 with additional refinements made to the mode spacing stabilization scheme. In this configuration, a crystal frequency reference source 405 is shared between two PLL control circuits 410, 415. PLL 410 is used to maintain and stabilize the longitudinal mode spacing in the EDFRL 305 within the finite limits of the passbands of the tunable mode selection filter 310. The tunable mode selection filter 310 also limits the number of modes that may exist in the EDFRL 305. Ideally, this mode spacing will correspond to the center frequencies of each of the passbands of the tunable mode selection filter 310.

The PLL control circuit 410, operating in conjunction with tunable mode selection filter 310, defines the geometrical boundary conditions that dictate which longitudinal modes may exist (within the finite bandwidth limits of the multiple passbands of tunable mode selection filter 310 ). The mode locking mechanism consists of the second PLL control circuit 415 which includes a voltage controlled oscillator (VCO) 420 and an optical Mach-Zehnder modulator (MZM) 425. Mode locking will force the allowed longitudinal optical modes in the EDFRL 305 to be placed exactly on the desired frequencies within each of the passbands of tunable mode selection filter 310.

The second PLL control circuit 415 is used to precisely maintain the output frequency of the VCO 420, which supplies a modulation signal to the MZM 425. The modulation frequency is set to the lowest desired reference data-rate/frequency that is to be ultimately provided by the all-optical reference clock 400 (in this specific example, the frequency is 10×N×5.184 MHz). This also corresponds to the mode spacing (passband center frequencies of the tunable mode selection filter 310) set up by the first PLL control circuit 410 in concert with the tunable mode selection filter 310 and the piezo-electric line-stretching drum 360. All harmonics of this fundamental data-rate/frequency will also be provided by the all-optical reference clock 400. The MZM 425, placed in the EDFRL 305, acts as a gating device by only allowing modes with the correct timing (frequency spacing) to propagate around the EDFRL 305. Modes with undesired frequencies are prohibited from existing because they are cutoff by the gating action of MZM 425. This mode locking mechanism forces the longitudinal optical modes to exist only on the desired frequency spacing and integer multiples there of (i.e., integer multiples of 10×N×5.184 MHz in this particular example). The second PLL control circuit 415, operating in conjunction with MZM 425, defines the timing requirements which the allowed modes must satisfy.

Hence, the all-optical reference clock 400 utilizes two complimentary stabilization schemes (geometrical boundary conditions and timing conditions) to achieve a highly stable output spectrum of harmonically related electrical reference signals. The all-optical reference clock 400 also provides a precisely spaced comb of optical reference signals with the optical frequency spacing of the comb spectrum equal to the fundamental electrical frequency generated by the EDFRL 305.

All of the disclosed circuitry can be built on a printed circuit board utilizing modem surface mount components. The longitudinal optical mode spacing control circuitry is most easily constructed by utilizing standard electronic PLL/frequency synthesizer integrated circuits (ICs) of which there are numerous manufacturers. Essential elements include frequency dividers (single or dual modules), phase/frequency detector, a charge pump or other searching mechanism to bring the EDFRL into the locked state. Additionally, a stable crystal oscillator is utilized as a frequency reference. If the lowest timing frequency to be locked is higher than the capability of the PLL ICs, an external frequency prescaler (divider) IC is used. IC operational amplifiers are used to provide lowpass filtering and also signal scaling so that control voltage (or current) levels are compatible with the devices being controlled. An operational amplifier is used as an amplifier in a photoreceiver circuit. A semiconductor III-V photodiode with a fiber optic pigtail is used to detect an optical signal and convert it into an electrical signal. For high frequency detection, a wide bandwidth photodetector must be utilized in conjunction with an amplifier of appropriate bandwidth.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An all-optical reference clock for outputting a stable radio frequency (RF) comb spectrum, comprising:
(a) a fiber ring laser having an effective loop circumference which produces a fundamental frequency mode spacing fₗ;
(b) a tunable mode selection filter in communication with the fiber ring laser; and
(c) a first phase locked loop (PLL) control circuit in communication with the fiber ring laser, the first PLL control circuit including:
(c1) a frequency reference source oscillating at the frequency f₁, and
(c2) a bandpass filter having a center frequency fₒ equal to a predetermined multiple of the frequency fₗ, wherein the all-optical reference clock is configured to output a plurality of equally spaced frequencies which include the frequency fₒ and the harmonics thereof, and the first PLL control circuit receives a sample of the spaced frequencies and adjusts the tunable mode selection filter to maintain the desired spacing between the spaced frequencies.

2. The all-optical reference clock of claim 1 further comprising:
(d) a line-stretching drum in communication with the first PLL control circuit, the line-stretching drum having a variable diameter, wherein the tunable mode selection filter includes a length of fiber wrapped around the line-stretching drum, and the mode selection filter is tuned as the diameter of the line-stretching drum changes in response to a signal received from the first PLL control circuit.

3. The all-optical reference clock of claim 2 wherein the line-stretching drum is a piezo-electric line-stretching drum.

4. The all-optical reference clock of claim 1 further comprising:
(d) a second PLL control circuit in communication with the frequency reference source of the first PLL control circuit, the second PLL control circuit including:
(d1) an optical modulator in communication with the fiber ring laser, the optical modulator prohibiting undesired frequencies from passing through; and
(d2) a voltage controlled oscillator (VCO) which supplies a modulation signal to the optical modulator, wherein the frequency of the modulation signal is set to the lowest frequency in the RF comb spectrum outputted by the all-optical reference clock.

5. The all-optical reference clock of claim 4 wherein the optical modulator is an optical Mach-Zehnder modulator.

6. The all-optical reference clock of claim 4 wherein the frequency of the modulation signal is about 51.84 MHz.

7. The all-optical reference clock of claim 1 wherein the tunable mode selection filter has a free spectral range (FSR) equal to about 51.84 MHz and the harmonics thereof.

8. The all-optical reference clock of claim 1 wherein the frequency fₗ is about 5.184 MHz.

9. The all-optical reference clock of claim 1 wherein the frequency fₒ is about 51.84 MHz.

10. The all-optical reference clock of claim 1 wherein the predetermined multiple is ten.

11. The all-optical reference clock of claim 1 wherein the fiber ring laser is an erbium doped fiber ring laser (EDFRL).

12. The all-optical reference clock of claim 1 wherein the tunable mode selection filter limits the number of the spaced frequencies.

13. An all-optical reference clock for outputting a stable radio frequency (RF) comb spectrum, comprising:
(a) a fiber ring laser having an effective loop circumference which produces a fundamental frequency mode spacing fₗ;
(b) an optical modulator in communication with the fiber ring laser, the optical modulator prohibiting undesired frequencies from passing through; and
(c) a voltage controlled oscillator (VCO) which supplies a modulation signal to the optical modulator, wherein the frequency of the modulation signal is set to the lowest frequency in the RF comb spectrum outputted by the all-optical reference clock.

14. The all-optical reference clock of claim 13 wherein the optical modulator is an optical Mach-Zehnder modulator.

15. The all-optical reference clock of claim 13 wherein the frequency of the modulation signal is about 51.84 MHz.

16. An all-optical reference clock for outputting a stable radio frequency (RF) comb spectrum, comprising:
(a) a fiber ring laser having an effective loop circumference which produces a fundamental frequency mode spacing fₗ;
(b) a tunable mode selection filter in communication with the fiber ring laser; and
(c) a line-stretching drum having a variable diameter, wherein the tunable mode selection filter includes a length of fiber wrapped around the line-stretching drum, and the mode selection filter is tuned as the diameter of the line-stretching drum changes in response to a control signal.

17. The all-optical reference clock of claim 16 further comprising:
(d) a phase locked loop (PLL) control circuit in communication with the fiber ring laser, the PLL control circuit sending the control signal to the line-stretching drum to tune the mode selection filter.

18. The all-optical reference clock of claim 17 wherein the PLL control circuit includes:
(d1) a frequency reference source oscillating at the frequency fₗ; and
(d2) a bandpass filter having a center frequency fₒ equal to a predetermined multiple of the frequency fₗ, wherein the all-optical reference clock is configured to output a plurality of equally spaced frequencies which include the frequency fₒ and the harmonics thereof, and the PLL control circuit receives a sample of the spaced frequencies and adjusts the tunable mode selection filter to maintain the desired spacing between the spaced frequencies.
